(19) United States
(12) Patent Application Publication
(10) Pub. No.: US 2008/0157920 A1
(43) Pub. Date: Jul. 3, 2008

(54) CALIBRATABLE UDS SECURITY CONCEPT FOR HEAVY-DUTY DIESEL ENGINE

(75) Inventor: Frank S. Groer, Stuttgart (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 11/940,051

(22) Filed: Nov. 14, 2007

Related U.S. Application Data
(60) Provisional application No. 60/877,419, filed on Dec. 28, 2006.

(51) Int. Cl. G06F 21/00; G07C 9/00

(52) U.S. Cl. 340/5.74

(57) ABSTRACT

A method for providing varying levels of security access to an engine controller using security levels and seed and key programs to calculate access codes for the levels of security access.

### CROSS-REFERENCE TO RELATED APPLICATIONS

The present application claims priority to U.S. Provisional Application Ser. No. 60/877,419 filed on Dec. 28, 2006, the contents of which are incorporated herein in their entirety.

### BACKGROUND OF THE INVENTION

1. Field of the Invention

The present invention relates to a calibratable security concept for heavy duty diesel engines that provides for different levels of security access to and engine controller software.

The present invention further relates to a seed and key security access to an engine controller that permits security access to memory or service routines as determined by a manufacturer.

The present invention further relates to a calibratable security access wherein different levels of access to engine controller software is authorized using a key and seed security access to prevent unauthorized manipulation of engine controller software by a third party.

2. Description of the Related Art

Gashin U.S. Pat. No. 5,606,315 discloses a microprocessor based electronic control module with an EEPROM for storing protected data that allows the data to be used internally, and allows for non-sensitive data to be accessed by external communication tools, but prohibits access to the protected data unless a password is first entered. The Data may be read from memory and the data or password may then be changed. For a given model of control module, an ID number is assigned to the password and stored in the module and can be read to allow the user to find the corresponding password on a secure list available only to authorized personnel. When a password can not be found and it is necessary to change the protected data, the unit can be recovered by a recover procedure wherein the secure data is first erased and then the security is deactivated to grant free access.

Rettig et al., U.S. Pat. No. 5,884,210 discloses a programmable electronic engine controller that includes customer programmable engine and vehicle operating parameters. A communications device is connectable to the engine controller. Stored in the communication device are predetermined set of parameters. The communication device downloads the engine and vehicle operating parameters that are present in the engine controller and compares those values to corresponding predetermined parameters and prints and excerpt report based on that comparison. The system of Rettig et al., '210 is useful in alerting fleet managers of tampering or alterations of vehicle operating software by resort to a print-out which is attainable from the controller.

McKenzie et al. U.S. Pat. No. 6,671,608 discloses a system and method for controlling an engine in a vehicle that provides the operator with an operating capability for a specified time that is established at predetermined intervals including determines whether the operator has tampered with the engine control system clock to obtain additional time for that particular operating capability. If the clock has been tampered with, one or more additional steps are taken, including logging the tampering event, and suspending any steps which would provide the particular operating capability to the operator for any additional time until the next interval or until the engine has been returned to personnel authorized to reprogram the engine control.

Akins et al., U.S. Pat. No. 6,678,606 discloses a system and method for detecting tampering with the software parameters and calibration data used by a vehicle controller. During authorized installation of the controller memory images, a hash function is applied to selected regions of the controller memory to obtain a stored hash value. Then, periodically, during operation of the vehicle, the hash function is applied to the then current contents of the controller memory to obtain calculated hash values. If the stored hash values do not match the calculated hash values, a fault is logged for future retrieval by service personnel.

Madau, U.S. Pat. No. 6,748,536 discloses a system for providing a key based access to data stored on a vehicle that allows the vehicle to be a critical link as a platform for mobile computing while preserving data security. Multiple hierarchies of key codes allow all users to have access to all vehicle functions but different memory partitions for storing data. The partitions may be used for storing user specific data including passwords, preference settings, and driving log data. The data may be encrypted by the key code to be secure even if the memory system is removed from the vehicle or the vehicle is stolen.

Hawig et al., U.S. Pat. No. 6,799,101 discloses a method for safe programming of an electrically erasable and programmable memory such as flash EEPROM in a control unit such as a vehicle ECU, utilizing a programming data set that is read into the control unit and evaluated in the control unit. The programming data set contains, besides a memory map to be programmed, an equipment description of the control units authorized for programming so that the control unit can perform an identity check to determine if it belongs to the range of authorized control units. If the identity check indicates that it is authorized for programming, reprogramming is performed using a programming device provided in the control unit itself.

### BRIEF SUMMARY OF THE INVENTION

The present invention is a method for providing varying levels of security access to an engine controller software to prevent unauthorized access and manipulation of engine controller software by third parties. The method is a seed and key security access for service routines or other access to the engine controller software. The method comprises specifying engine control functions by a level of security access; rejecting access to unauthorized levels of security based upon an access code and permitting access to a requested level of security when an authorized access code is implemented. When an unauthorized access is attempted, the access is denied and a log is created in permanent memory to identify the unauthorized party. A UDS link is generally used to communicate with the engine controller. However, other links, such as SAE link J 1587 and/or J 1939 may also be utilized.

The access code is determined by a key calculation formula. At least one level of security access is created, and preferably up to 5 such levels may be created. The service access level is calibratable and applies to service routines and EEPROM UDS write functions. The service routine and EEPROM UDS write function is executable only if the related security access is correctly calculated.

### BRIEF DESCRIPTION OF THE DRAWINGS

FIG. 1 is a schematic representation of a heavy duty diesel engine with electronic control.

FIG. 2 is a schematic representation of the software flow chart in the present invention.

### DETAILED DESCRIPTION OF THE INVENTION

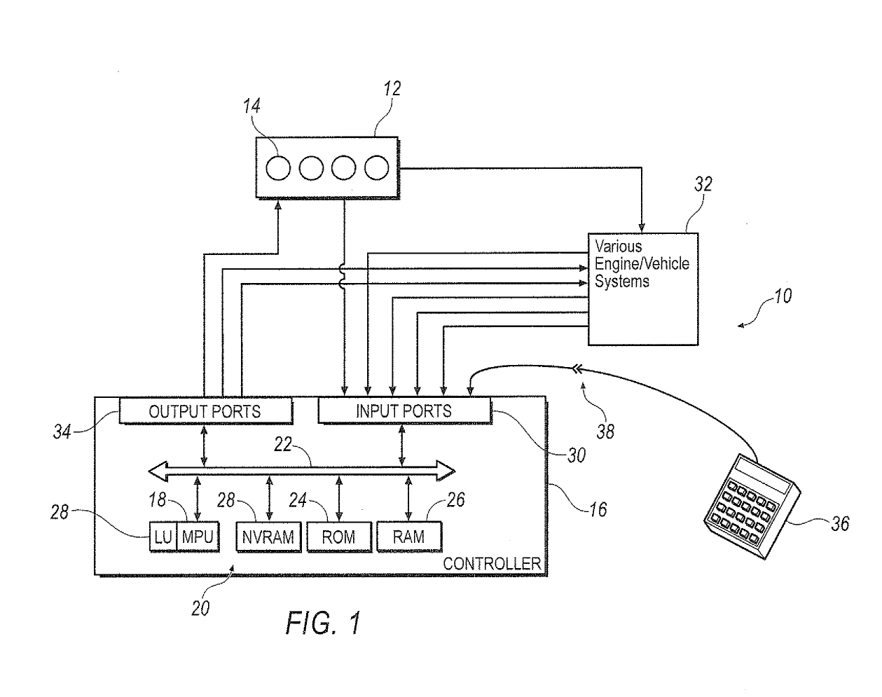

Turning now to the drawings where like numeral depict like structures and particularly to FIG. 1, there is schematically represented a perspective view illustrating a compression-ignition internal combustion engine system 10 incorporating various features according to the present invention is shown. The engine 12 may be implemented in a wide variety of applications including on-highway trucks, construction equipment, marine vessels, stationary generators, pumping stations, and the like. The engine 12 generally includes a plurality of cylinders disposed below a corresponding cover, indicated generally by reference numeral 14.

In a preferred embodiment, the engine 10 is a multi-cylinder compression ignition internal combustion engine, such as a 3, 4, 6, 8, 12, 16, or 24 cylinder diesel engine. However, the engine 12 may be implemented having any appropriate number of cylinders 14, the cylinders having any appropriate displacement and compression ratio to meet the design criteria of a particular application. Moreover, the present invention is not limited to a particular type of engine or fuel. The present invention may be implemented in connection with any appropriate engine (e.g., Otto cycle, Rankine cycle, Miller cycle, etc.) using an appropriate fuel to meet the design criteria of a particular application.

A controller 16 preferably comprises a programmable microprocessor 18 in communication with (i.e., coupled to) various computer readable storage media 20 via at least one data and control bus 22. The computer readable storage media 20 may include any of a number of devices such as read only memory (ROM) 24, random access memory (RAM) 26, and non-volatile (keep-alive) random access memory (NVRAM) 28.

The various types of computer-readable storage media 20 generally provide short-term and long-term storage of data (e.g., at least one lookup table, LUT, at least one operation control routine, at least one mathematical model for EGR control, etc.) used by the controller 16 to control the engine 10. The computer-readable storage media 20 may be implemented by any of a number of known physical devices capable of storing data representing instructions executable by the microprocessor 18. Such devices may include PROM, EPROM, EEPROM, flash memory, and the like in addition to various magnetic, optical and combination media capable of temporary and permanent data storage.

The computer-readable storage media 20 may include data representing program instructions (e.g., software), calibrations, routines, steps, methods, blocks, operations, operating variables, and the like used in connection with associated hardware to control the various systems and subsystems of the engine 10, and the vehicle. The computer readable storage media 20 generally have instructions stored thereon that may be executable by the controller 16 to control the internal combustion engine 10. The program instructions may direct the controller 16 to control the various systems and subsystems of the vehicle where the engine 12 is implemented, with the instructions being executed by microprocessor 20, and optionally, instructions may also be executed by any number of logic units 28. The input ports 30 may receive signals from the various engine and vehicle systems, including sensors and switches generally designated at 32, and the controller 16 may generate signals (e.g., the signals ACT and ADJ) at output ports 34. The output signals are generally presented (or transmitted) to the various vehicle components.

A data, diagnostics, and programming interface 36 may also be selectively connected to the controller 32 via a bus and connector 38 to exchange various information therebetween. The interface 36 may be used to change values within the computer readable storage media 20, such as configuration settings, calibration variables, and the like.

As used throughout the description of the present invention, at least one selectable (i.e., programmable, predetermined, modifiable, etc.) constant, limit, set of calibration instructions, calibration values (i.e., threshold, level, interval, value, amount, duration, etc.) or range of values may be selected by any of a number of individuals (i.e., users, operators, owners, drivers, etc.) via a programming device, such as the device 36 selectively connected via an appropriate plug or connector 38 to the controller 16.

Rather than being primarily controlled by software, the selectable or programmable constant and limit (or range) values may also be provided by an appropriate hardware circuit having various switches, dials, and the like. Alternatively, the selectable or programmable limit and range may also be changed using a combination of software and hardware without departing from the spirit of the present invention. However, the at least one selectable value or range may be predetermined and/or modified by any appropriate apparatus and method to meet the design criteria of a particular application. Any appropriate number and type of sensors, indicators, actuators, etc. may be implemented to meet the design criteria of a particular application.

In at least one mode of operation, the controller 16 may receive signals from the various vehicle sensors and switches, and execute control logic embedded in hardware and software to control the engine 12, various engine and vehicle systems 32, and the like. In one example, the controller 16 is implemented as at least one implementation of a DDEC controller available from Detroit Diesel Corporation, Detroit, Mich. Various other features of the DDEC controller are described in detail in a number of different U.S. patents assigned to Detroit Diesel Corporation. However, the present invention may be implemented in connection with any appropriate controller to meet the design criteria of a particular application.

Control logic may be implemented in hardware, firmware, software, or combinations thereof. Further, control logic may be executed by the controller 16, in addition to and by any of the various systems and subsystems of the vehicle or other installation where the controller 16 is implemented. Yet further, although in a preferred embodiment, the controller 16 includes the microprocessor 20, any of a number of known programming and processing techniques, algorithms, steps, blocks, processes, routines, strategies and the like may be implemented to control the engine 12, and the various engine and vehicle components 32. Further, the engine controller 16 may receive information in a variety of ways. For example, engine 12 systems information may be received over a data link, at a digital input, or at a sensor input of the engine controller 16.

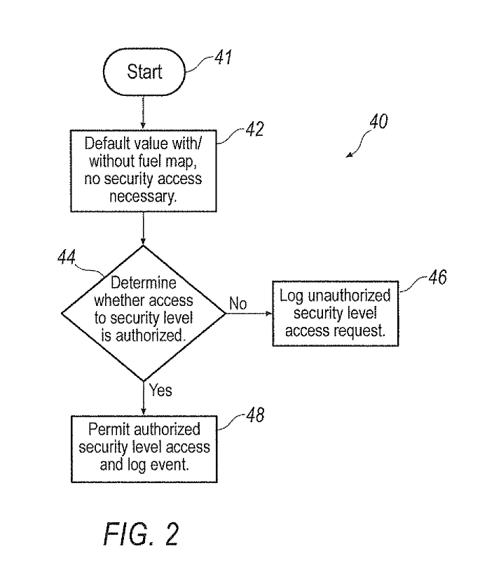

Turning to FIG. 2, there is shown a schematic representation of the software flow chart of one method of the present invention. With reference to FIG. 1, the controller 16 is accessible by the service tool for routine access to the operating software. This access is desirable in order to permit service personnel to perform updates or other service routines to the operating software to ensure that the controller has the most up to date version of software, and that any service routines can be effectively implemented. However, there has been a long felt need to provide for a system that permits security level access to the controller to prevent manipulation of the engine controller operating software by third parties. Turning again to FIG. 2, there is shown method 40 wherein step 41 is a default value that may or may not permit access to the fuel map as no security access code is necessary to access this level. Step 42 is specifying engine control functions by a level of security. In this step, each of desired engine functions is assigned a security level access, whereby only those parties with the proper security level access may access the engine function at that level. The security access level is calibratable and applies to service routines and EEPROM write functions. The EEPROM write function is executable only if the related security access is correctly identified. The security access level is calculated in any number of ways, and it is contemplated to use a key calculation formula. While at least one level off security access is contemplated, it is preferred to create up to 5 levels of security access codes for access by third parties to the controller software.

Step 44 is determining whether the access security level is authorized to run the requested service routine or EEPROM write function. If not, step 46 will cause a NACK code and create a log of the event. If the access security level is authorized to run the requested service routine or EEPROM write function, step 48 permits the authorized security level access and logs the event.

While the invention has been described as stated above, the words used are words of description and not words of limitation. Those skilled in the art will understand that many variations and modifications are possible without departing from the scope and spirit of the invention as set forth in the appended claims.

What is claimed as new and desired to be protected by Letters Patent of the United States is:

1. A method of providing varying levels of security access to an engine controller software, said controller having non-volatile memory, comprising:
a. specifying engine control functions by level of security;
b. rejecting access to unauthorized levels of security based access code;
c. permitting access requested level of security when authorized access code is implemented.

2. The method of claim 1 wherein said access code is determined by a key calculation formula.

3. The method of claim 1, further including five levels of security.

4. The method of claim 1, wherein a code is generated in said engine controller if an unauthorized security access is requested as a log.

5. The method of claim 1, further including permitting default access to default information without requiring a security access level code.
